(19) United States
(12) Patent Application Publication
(10) Pub. No.: US 2007/0014367 A1
(43) Pub. Date: Jan. 18, 2007

(54) Extensible architecture for multi-standard variable length decoding

(76) Inventor: Yaxiong Zhou, San Jose, CA (US)

Correspondence Address: MAYER, BROWN, ROWE & MAW LLP, P.O. BOX 2828, CHICAGO, IL, 60690-2828, US

(21) Appl. No.: 11/181,220

(22) Filed: Jul. 13, 2005

(51) Int. Cl. H04N 11/04; H04N 11/02

(52) U.S. Cl. 375/240.23; 375/240.25

(57) ABSTRACT

An architecture capable of carrying out variable length decoding for multiple video compression formats (e.g., MPEG1/2/4, H.263, H.264, Microsoft WMV9, and Sony Digital Video), is disclosed. In one embodiment, the VLD process is divided into two parts: flow control and table lookup. The flow control part can be performed by a low-cost microcontroller or other suitable processor, and the table lookup part is performed by hardware logic. With different firmware, the microcontroller handles flow control of all the existing video formats and can be adapted to accommodate new formats without any hardware change. Each piece of lookup table logic is connected to the microcontroller as extended instructions. In operation, during the decoding process, the flow control firmware executes one of these extended instructions whenever a table lookup operation is required. The architecture can be implemented, for example, as a system-on-chip decoder for use in HDTV applications and the like.

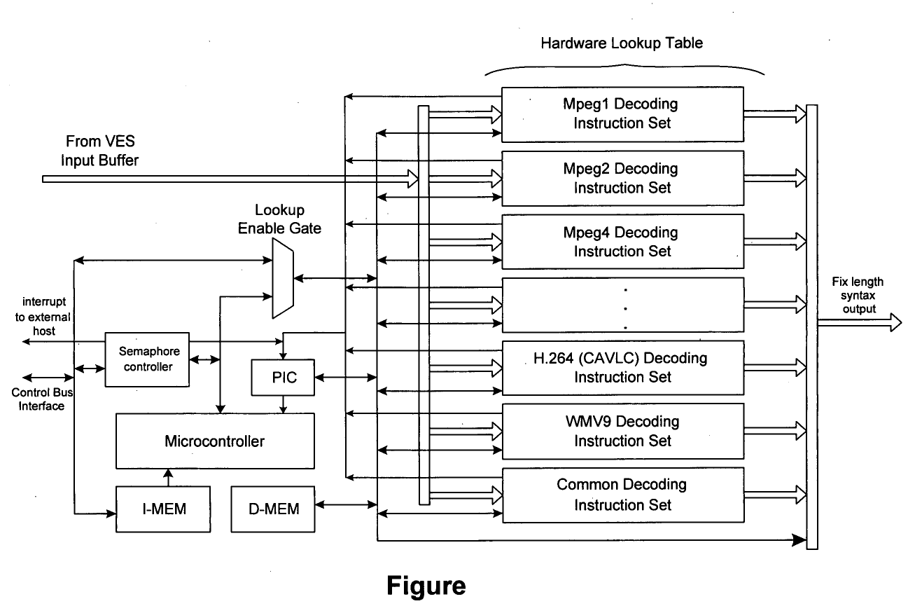

### RELATED APPLICATIONS

This application claims the benefit of U.S. Provisional Application No. 60/635,114, filed on Dec. 10, 2004. In addition, this application is related to U.S. Application No. (not yet known), filed July, xx 2005, titled “Two Pass Architecture for H.264 CABAC Decoding Process” <attorney docket number 22682-09877>. Each of these applications is herein incorporated in its entirety by reference.

### FIELD OF THE INVENTION

The invention relates to video decoding, and more particularly, to the variable length decoding for multiple video compression formats such as MPEG1, MPEG2, MPEG4, H.263, H.264, Microsoft WMV9, and Sony Digital Video.

### BACKGROUND OF THE INVENTION

There are a number of video compression standards available, including MPEG1/2/4, H.263, H.264, Microsoft WMV9, and Sony Digital Video, to name a few. Generally, such standards employ a number of common steps in the processing of video images.

First, video images are converted from RGB format to the YUV format. The resulting chrominance components can then be filtered and sub-sampled of to yield smaller color images. Next, the video images are partitioned into 8×8 blocks of pixels, and those 8×8 blocks are grouped in 16×16 macro blocks of pixels. Two common compression algorithms are then applied. One algorithm is for carrying out a reduction of temporal redundancy, the other algorithm is for carrying out a reduction of spatial redundancy.

Temporal redundancy is reduced by motion compensation applied to the macro blocks according to the picture structure. Encoded pictures are classified into three types: I, P, and B. I-type pictures represent intra coded pictures, and are used as a prediction starting point (e.g., after error recovery or a channel change). Here, all macro blocks are coded without prediction. P-type pictures represent predicted pictures. Here, macro blocks can be coded with forward prediction with reference to previous I-type and P-type pictures, or they can be intra coded (no prediction). B-type pictures represent bi-directionally predicted pictures. Here, macro blocks can be coded with forward prediction (with reference to previous I-type and P-type pictures), or with backward prediction (with reference to next I-type and P-type pictures), or with interpolated prediction (with reference to previous and next I-type and P-type pictures), or intra coded (no prediction). Note that in P-type and B-type pictures, macro blocks may be skipped and not sent at all. In such cases, the decoder uses the anchor reference pictures for prediction with no error.

Spatial redundancy is reduced applying a discrete cosine transform (DCT) to the 8×8 blocks and then entropy coding by Huffman tables the quantized transform coefficients. In particular, spatial redundancy is reduced applying eight times horizontally and eight times vertically an 8×1 DCT transform. The resulting transform coefficients are then quantized, thereby reducing to zero small high frequency coefficients. The coefficients are scanned in zigzag order, starting from the DC coefficient at the upper left corner of the block, and coded with variable length coding (VLC) using Huffman tables. The DCT process significantly reduces the data to be transmitted, especially if the block data is not truly random (which is usually the case for natural video). The transmitted video data consists of the resulting transform coefficients, not the pixel values. The quantization process effectively throws out low-order bits of the transform coefficients. It is generally a lossy process, as it degrades the video image somewhat. However, the degradation is usually not noticeable to the human eye, and the degree of quantization is selectable. As such, image quality can be sacrificed when image motion causes the process to lag. The VLC process assigns very short codes to common values, but very long codes to uncommon values. The DCT and quantization processes result in a large number of the transform coefficients being zero or relatively simple, thereby allowing the VLC process to compress these transmitted values to very little data. Note that the transmitter encoding functionality is reversible at the decoding process performed by the receiver. In particular, the receiver performs dequantization (DEQ), inverse DCT (IDCT), and variable length decoding (VLD) on the coefficients to obtain the original pixel values.

Conventional implementations for carrying out the VLD receiver processes generally use a variable length coding table to code syntax elements. But the way these conventional processes define the syntax elements and the tables used to code the syntax elements differ significantly from standard to standard. One existing method is to use a generic processor to perform the variable length decoding. With different firmware, the processor can support different video standards. The problem is that the processing power of such configurations is typically not sufficient to match the requirement of high definition decoding. Also, the processing power cannot provide a constant throughput, which is required in a non external buffer system.

What is needed, therefore, are architectures capable of carrying out variable length decoding for multiple video compression formats.

### SUMMARY OF THE INVENTION

One embodiment of the present invention provides a device for performing variable length decoding architecture configured for multiple video compression formats. The device includes a microcontroller for carrying out variable length decoding flow control for a plurality of video formats, and a lookup table including a decoding instruction set for each of the plurality of video formats. Each decoding instruction set includes at least one decoding instruction implemented in hard-coded logic that decodes a particular syntax element of one of the video formats. The plurality of video formats may include, for example, two or more of MPEG1, MPEG2, MPEG4, H.263, H.264, Microsoft WMv9, and Sony Digital Video. The device may include an instruction memory for storing decoding flow control instructions to be executed by the microcontroller. The device may include a data memory for storing variable length decoding data. The device may include a semaphore controller for controlling communication between the microcontroller and an external host. The device may include a lookup enable gate for enabling the decoding instruction sets of the lookup table in response to input from at least one of the microcontroller and an external host. The device may include a programmable interrupt controller for interrupting the decoding flow control as needed to carry out variable length decoding. The device can be implemented, for example, as a system-on-chip for a video/audio decoder for use in high definition television broadcasting (HDTV) applications, or other video applications. The device can be further configured to perform other video decoding processes, including dequantization (DEQ) and inverse discrete cosine transform (IDCT). The lookup table may further include a common decoding instruction set that includes decoding instructions used by more than one of the video formats.

Another embodiment of the present invention provides a device for performing variable length decoding architecture configured for multiple video compression formats (e.g., MPEG1, MPEG2, MPEG4, H.263, H.264, Microsoft WMV9, and Sony Digital Video). The particular device includes a programmable processor for carrying out variable length decoding flow control for a plurality of video formats, and a hardware logic lookup table including at least one piece of table lookup logic for each of the plurality of video formats, where each piece of lookup table logic is operatively connected to the microcontroller as extended instructions for decoding a particular syntax element of one of the video formats. In one such embodiment, and during a decoding process, flow control firmware of the programmable processor executes one or more of the extended instructions whenever a table lookup operation is required. The hardware logic lookup table may further include a common decoding instruction set that includes hardware logic decoding instructions used by more than one of the video formats. The device can be implemented, for example, as a system-on-chip for a video/audio decoder, and can be used for use in a number of video/broadcast applications.

The features and advantages described herein are not all-inclusive and, in particular, many additional features and advantages will be apparent to one of ordinary skill in the art in view of the figures and description. Moreover, it should be noted that the language used in the specification has been principally selected for readability and instructional purposes, and not to limit the scope of the inventive subject matter.

### BRIEF DESCRIPTION OF THE DRAWINGS

The FIGURE is a block diagram of a variable length decoding architecture configured for multiple video compression formats, in accordance with one embodiment of the present invention.

### DETAILED DESCRIPTION OF THE INVENTION

An architecture capable of carrying out variable length decoding for multiple video compression formats, such as MPEG1/2/4, H.263, H.264, Microsoft WMV9, and Sony Digital Video, is disclosed. The architecture can be implemented, for example, as a system-on-chip (SOC) for a video/audio decoder for use in high definition television broadcasting (HDTV) applications, or other such applications. Note that the decoder can be further configured to perform other video decoding processes as well, such as DEQ and IDCT.

In one embodiment, the process of variable length decoding is divided into two parts: flow control and table lookup. The flow control part can be performed, for example, by a low-cost microcontroller, and the table lookup part is performed by hardware logic. With different firmware, the microcontroller can handle the flow control of all the existing video formats and can be adapted to accommodate new formats without any hardware change. The table lookup functions of the different video formats can be implemented with pure hardware, where each format has its own piece of table lookup logic. Each piece of lookup table logic is connected to the microcontroller as extended instructions. In operation, during the decoding process, the flow control firmware executes one of these extended instructions whenever a table lookup operation is required.

By using hard wired logic to perform the table lookup, the performance of variable length decoding is increased dramatically. Likewise, using a microcontroller to handle the complicated flow control minimizes the hardware design effort and increases the flexibility of the architecture (e.g., to adapt to newer standards). Thus, the architecture allows the decoding process to be partitioned in a very effective and efficient manner.

Architecture

The FIGURE is a block diagram of a variable length decoding architecture configured for multiple video compression formats, in accordance with one embodiment of the present invention.

The architecture can be implemented, for example, as an application specific integrated circuit (ASIC) or other purpose-built semiconductor. A partitioned approach is used to provide flexibility in carrying out flow control (e.g., using a programmed microcontroller), and speed in carrying out table lookup functions (e.g., using hardware logic). Such a configuration enables high definition decoding, and provides a constant throughput.

This architecture can be used, for example, to implement code index parser (CIP) modules discussed in the previously incorporated U.S. Application No. (not yet known), filed June, xx 2005, titled “Two Pass Architecture for H.264 CABAC Decoding Process” <attorney docket number 22682-09877>. In one such embodiment, a first CIP module is used for parsing and decoding the syntax elements from the input video elementary stream (VES) at the level of slice and the levels above the slice. A CABAC module (or other decoding module, such as a multi-standard decoding module) is used for un-wrapping the strong dependency of arithmetic and context between the consecutive bits from the input VES, transferring the input VES to a video transformed stream (VTS) format, and storing it in an external memory (e.g., DRAM). In one particular case, the VTS is slightly expanded over the original data by about 10%-25% in size. This expansion eliminates all the dependency between the bits within the bit stream. The expanded VTS is then fed back from the external memory (e.g., DRAM) into a second CIP module for the second pass of the two pass data path approach, at a much higher throughput for syntax element parsing. This high throughput rate enables the speed of the syntax element parsing performance at the same performance level with subsequent stage pipeline video decoding processes. In one such embodiment, the external memory (e.g., DRAM) is used as an infinite length buffer to compensate and smooth out the variability of the output syntax element from the CABAC module, so that the entire video decoding engine has a consistent pipeline performance to meet a target performance requirement of one high definition (HD) bit stream and one standard definition (SD) bit stream.

As can be seen, the variable length decoding architecture of the FIGURE includes a microcontroller, a data memory (D-MEM), and instruction memory (I-MEM), a semaphore controller, a lookup enable gate, a programmable interrupt controller (PIC), a hardware logic lookup table. The hardware lookup table supports a number of different video formats with decoding instruction sets, which in this embodiment include MPEG1/2/4 instruction sets, an H.264 instruction set, a Microsoft WMV9 instruction set, a common decoding instruction set, and other formats (e.g., H.263 and Sony Digital Video).

In operation, this example variable length decoding architecture parses and decodes the syntax elements from the original input VES, which contains the information at the stream sequence or picture levels. The subsequent decoding process (e.g., such as CABAC of H.264) is done at the slice and macroblock level of the input VES. Thus, the variable length decoding architecture of this embodiment parses the input VES, and outputs the corresponding macroblock stream and slice stream. Each of these streams can be passed as a fixed length syntax output to the subsequent decoding module (not shown), to form the VTS.

The microcontroller can be configured with different firmware to carry out flow control, as previously explained. In one particular embodiment, a 16-bit microcontroller is used to perform the decoding flow control of all the supported video formats, although any one of a number of conventional programmable processor environments can be used here, as will be apparent in light of this disclosure. The microcontroller serves as the only master of the internal control bus when enabled. In addition, note that the internal control bus address can be directly mapped to the codec control bus address space (not shown). When the microcontroller is disabled, an external host can serve as the master of the internal control bus.

The instruction memory (I-MEM) stores instructions to be executed by the microcontroller. Note that this memory can be integrated into the microcontroller or exist as a discrete memory module. In one particular embodiment, the instruction memory is written by the external host though the codec control bus. This configuration allows for modification to the control flow, such as adding or removing a video compression standard, or adjusting an existing control flow.

The data memory (D-MEM) is used to store data associated with the variable length decoding process, such as the slice and upper level syntax elements, H.264 NC context, and the MPEG4 and WMV9 bit planes. Other data and/or information relevant to the decoding process that can be stored in the data memory will be apparent in light of this disclosure.

The internal programmable interrupt controller (PIC) has a number of selectable (via software) options for interrupting the flow control as needed to carry out the variable length decoding process. In general, each piece of lookup table logic or “decoding instruction set” of the hardware logic lookup table is adapted to provide interruption request (IRQ) signals to the PIC, which prioritizes the IRQ signals and sends the highest priority to the microcontroller. Various internal interrupts can error report, such as a failure in decoding a syntax element. Many interrupt schemes can be implemented here, depending on desired processing priorities.

The semaphore controller provides a semaphore array between the external host and the microcontroller, and is used for communication between the two processors. In this embodiment, the semaphore controller can be accessed by both the external host and microcontroller at the same time.

A decoding instruction is a piece of hard-coded dedicated logic that decodes a certain kind of syntax element of a certain kind of video format, such as the H.264 Exponential-Golomb entropy coding or MPEG1/2/4 coding. Alternatively, a decoding instruction is a ROM based lookup table. A decoding instruction set is a group of such decoding instructions that is used for a certain kind of video format. In this example embodiment, the hardware lookup table includes decoding instruction sets for MPEG 1/2/4, H.264 content adaptive variable length coding (CALVC), and WMV9. There is also a common decoding instruction set that includes all the decoding instructions that will be used by more than one format.

Each piece of lookup table logic (decoding instruction set) of the hardware logic lookup table is enabled by the lookup enable gate. In this embodiment, the lookup enable gate is an OR gate, and receives one input signal from the local microcontroller and another input signal from the external host (via the control bus). If one of the input signals indicate that a logic lookup is enabled, then the lookup enable gate output goes active, thereby enabling each of the decoding instruction sets of the hardware logic lookup table.

Decoding Instructions

In operation, a decoding instruction receives the video stream as input, performs the variable length table look-up, and outputs the fixed-length result. A decoding instruction set contains all the table look-up functions for a particular video format. For example, consider the 11 instructions from the MPEG2 decoding instruction set, as listed in Table 1.

TABLE 1

| | Table ID |
|---|---|
| | in MPEG2 |
| Decoding Instruction Name | Spec |
| Variable length codes for macroblock_address_increment | B-1 |
| Variable length codes for macroblock_type in I-pictures | B-2 |
| Variable length codes for macroblock_type in P-pictures | B-3 |
| Variable length codes for macroblock_type in B-pictures | B-4 |
| Variable length codes for coded_block_pattern | B-9 |
| Variable length codes for motion_code | B-10 |
| Variable length codes for dmvector[t] | B-11 |
| Variable length codes for dct_dc_size_luminance | B-12 |
| Variable length codes for dct_dc_size_chrominance | B-13 |
| DCT coefficients Table zero | B-14 |
| DCT coefficients Table one | B-15 |

Each of the decoding instructions is essentially a hardware implementation of a variable length code table from the MPEG2 specification. For instance, consider the dct_dc_size_luminance table as an example. The table (referred to as B-12 in the MPEG2 specification) looks like:

TABLE 2

| Variable length code | dct_dc_size_luminance |
|---|---|
| 100 | 0 |
| 00 | 1 |
| 01 | 2 |
| 101 | 3 |
| 110 | 4 |
| 1110 | 5 |
| 1111 0 | 6 |
| 1111 10 | 7 |
| 1111 110 | 8 |
| 1111 1110 | 9 |
| 1111 1111 0 | 10 |
| 1111 1111 1 | 11 |

Here is shown a Verilog implementation of this table:

```
module dct_dc_size_luminance (bitStream,dcSize);
input [8:0] bitStream;
output [3:0] dcSize;
reg [3:0] dcSize;
always@(bitStream)
  casez({bitStream})
    {3′b100, 6′h?} : begin dcSize = 4′d0; end
    {2′b00, 7′h?} : begin dcSize = 4′d1; end
    {2′b01, 7′h?} : begin dcSize = 4′d2; end
    {3′b101, 6′h?} : begin dcSize = 4′d3; end
    {3′b110, 6′h?} : begin dcSize = 4′d4; end
    {4′b1110, 5′h?} : begin dcSize = 4′d5; end
    {5′b11110, 4′h?} : begin dcSize = 4′d6; end
    {6′b111110, 3′h?} : begin dcSize = 4′d7; end
    {7′b1111110, 2′h?} : begin dcSize = 4′d8; end
    {8′b11111110,1′h?} : begin dcSize = 4′d9; end
    {9′b111111110 } : begin dcSize = 4′d10;end
    {9′b111111111 } : begin dcSize = 4′d11;end
  endcase
endmodule
```

As can be seen, this example decoding instruction takes 9 bits of video stream as input (bitStream), and uses a case statement to map it to a 4-bit number output (dcSize). Since it is implemented in hard wired logic, this mapping is very fast. This instruction only takes 1 cycle to finish the table mapping function. If implemented in software, the same variable length table look-up would likely take more than 10 generic CPU instructions.

Each of the specifications for MPEG1/2/4, H.263, H.264, Microsoft WMV9, and Sony Digital Video is herein incorporated in its entirety by reference, including their respective coding instruction tables. Each decoding instruction can be implemented in a similar fashion as shown here, and as will be apparent in light of this disclosure. Note that modeling and synthesis techniques other than Verilog can be used to describe and design the hardware logic prior to fabrication.

The foregoing description of the embodiments of the invention has been presented for the purposes of illustration and description. It is not intended to be exhaustive or to limit the invention to the precise form disclosed. Many modifications and variations are possible in light of this disclosure. It is intended that the scope of the invention be limited not by this detailed description, but rather by the claims appended hereto.

What is claimed is:

1. A device for performing variable length decoding architecture configured for multiple video compression formats, comprising:
a microcontroller for carrying out variable length decoding flow control for a plurality of video formats; and
a lookup table including a decoding instruction set for each of the plurality of video formats, each decoding instruction set including at least one decoding instruction implemented in hard-coded logic that decodes a particular syntax element of one of the video formats.

2. The device of claim 1 further comprising:
an instruction memory for storing decoding flow control instructions to be executed by the microcontroller.

3. The device of claim 1 further comprising:
a data memory for storing variable length decoding data.

4. The device of claim 1 further comprising:
a semaphore controller for controlling communication between the microcontroller and an external host.

5. The device of claim 1 further comprising:
a lookup enable gate for enabling the decoding instruction sets of the lookup table in response to input from at least one of the microcontroller and an external host.

6. The device of claim 1 further comprising:
a programmable interrupt controller for interrupting the decoding flow control as needed to carry out variable length decoding.

7. The device of claim 1 wherein the device is implemented as a system-on-chip for a video/audio decoder for use in high definition television broadcasting (HDTV) applications.

8. The device of claim 1 wherein the device is further configured to perform other video decoding processes, including dequantization (DEQ) and inverse discrete cosine transform (IDCT).

9. The device of claim 1 wherein the lookup table further includes a common decoding instruction set that includes decoding instructions used by more than one of the video formats.

10. The device of claim 1 wherein the plurality of video formats include two or more of MPEG1, MPEG2, MPEG4, H.263, H.264, Microsoft WMV9, and Sony Digital Video.

11. A device for performing variable length decoding architecture configured for multiple video compression formats, comprising:
a microcontroller for carrying out variable length decoding flow control for a plurality of video formats;
an instruction memory for storing decoding flow control instructions to be executed by the microcontroller;
a data memory for storing variable length decoding data;
a semaphore controller for controlling communication between the microcontroller and an external host;
a lookup enable gate for enabling the decoding instruction sets of the lookup table in response to input from at least one of the microcontroller and an external host;
a programmable interrupt controller for interrupting the decoding flow control as needed to carry out variable length decoding; and
a lookup table including a decoding instruction set for each of the plurality of video formats, each decoding instruction set including at least one decoding instruction implemented in hard-coded logic that decodes a particular syntax element of one of the video formats.

12. The device of claim 11 wherein the device is implemented as a system-on-chip for a video/audio decoder for use in high definition television broadcasting (HDTV) applications.

13. The device of claim 11 wherein the device is further configured to perform other video decoding processes, including dequantization (DEQ) and inverse discrete cosine transform (IDCT).

14. The device of claim 11 wherein the plurality of video formats include two or more of MPEG1, MPEG2, MPEG4, H.263, H.264, Microsoft WMV9, and Sony Digital Video.

15. A device for performing variable length decoding architecture configured for multiple video compression formats, comprising:
a programmable processor for carrying out variable length decoding flow control for a plurality of video formats; and
a hardware logic lookup table including at least one piece of table lookup logic for each of the plurality of video formats, where each piece of lookup table logic is operatively connected to the microcontroller as extended instructions for decoding a particular syntax element of one of the video formats.

16. The device of claim 15 wherein, during a decoding process, flow control firmware of the programmable processor executes one or more of the extended instructions whenever a table lookup operation is required.

17. The device of claim 15 wherein the hardware logic lookup table further includes a common decoding instruction set that includes hardware logic decoding instructions used by more than one of the video formats.

18. The device of claim 15 wherein the device is implemented as a system-on-chip for a video/audio decoder for use in high definition television broadcasting (HDTV) applications.

19. The device of claim 15 wherein the device is further configured to perform other video decoding processes, including dequantization (DEQ) and inverse discrete cosine transform (IDCT).

20. The device of claim 15 wherein the plurality of video formats include two or more of MPEG1, MPEG2, MPEG4, H.263, H.264, Microsoft WMV9, and Sony Digital Video.
